(19) United States
(12) Patent Application Publication
(10) Pub. No.: US 2012/0159310 A1
(43) Pub. Date: Jun. 21, 2012

(54) METHOD FOR CONVERTING MOBILE WEB APPLICATION INTO NATIVE APPLICATION AND APPARATUS USING THE SAME

(75) Inventors: Yoon-Seop CHANG, Daejeon (KR); Seong Ho Lee, Daejeon (KR); Jae Chul Kim, Daejeon (KR); Kyung Ok Kim, Daejeon (KR); Chang Rak Yoon, Daejeon (KR); Hak Cheol Kim, Daejeon (KR); Ki Jung Lee, Gyeonggi-do (KR); Sung Woong Shin, Daejeon (KR)

(73) Assignee: Electronics and Telecommunications Research Institute, Daejeon (KR)

(21) Appl. No.: 13/325,965

(22) Filed: Dec. 14, 2011

(30) Foreign Application Priority Data
Dec. 16, 2010 (KR) 10-2010-0129479

(51) Int. Cl. G06F 17/00

(52) U.S. Cl. 715/239

(57) ABSTRACT

A method for converting a mobile web application into a native application (the term “app” has the same meaning as the native application) and an apparatus using the method are disclosed. The method for converting a mobile web application into a native application may include: the steps of receiving at least one of a web implementation document that implements the mobile web application and a uniform resource locator (URL) for a local file; separating and analyzing a user interface element of the mobile web application based on the at least one of the web implementation document and the local file; and converting the mobile web application into the native application by mapping the analyzed user interface element to a native control that implements the native application.

### CROSS-REFERENCE TO RELATED PATENT APPLICATION

This application claims the benefit of Korean Patent Application No. 10-2010-0129479, filed on Dec. 16, 2010, in the Korean Intellectual Property Office, the disclosure of which is incorporated herein in its entirety by reference.

### BACKGROUND OF THE INVENTION

1. Field of the Invention

The present invention relates to a method for converting a mobile web application into a native application and an apparatus using the method and, more particularly, to a method for converting a mobile web application into another format and an apparatus for implementing the method.

2. Description of the Related Art

With the proliferation of smart phones, information providing tools which can be used in mobile devices include native applications (hereinafter, the term “app” has the same meaning as the native application) and mobile webs.

A mobile web is a web which is formed separately from a web used in a typical PC in terms of mobile network environments. The mobile web may be viewed through a mobile web browser installed in a smart phone.

According to the mobile web, the entire page of the mobile web including advertisements is loaded, and thus the loading speed of the web page is low. Moreover, most of mobile terminals have small screens, and thus it is necessary to enlarge the screen to view specific information in detail.

The app has a loading speed higher than that of the mobile web and is formed in consideration of the screen size of the mobile terminal (e.g., smart phone) in which the content is executed. As a result, the configuration of a menu through which specific functions can be executed is easier to select than the mobile web, and thus it is not necessary to separately enlarge or reduce the screen.

Moreover, while the mobile web can be used only in an online environment, the app can be used even in an offline environment.

The greatest limitation of the mobile web is the data loading speed lower than that of the app. In the app, only the content which has been optimized for the smart phone can be received from a server and provided. However, the web page has been developed to be provided to a desktop computer, and thus it will take a relatively long time to load the web page on the mobile terminal.

In the case of the app, information is transmitted through a transport layer, the fourth layer of the open systems interconnection (OSI). However, in the case of the mobile web, information is transmitted through an application layer, the highest layer of the OSI using hypertext transfer protocol (HTTP) as a web standard. For such reasons, the loading speed of the mobile web is lower than that of the app. Further, in the HTTP protocol, connection and disconnection are frequently conducted whenever a page is loaded, and thus it takes considerable time to establish and cancel the connection.

In addition, an important factor that affects the difference in performance between the mobile web and the app is the speed at which the content is displayed on the screen. The speed at which the browser displays the content on the screen depends on the performance of WebKit and JavaScript engines, and the speed of the mobile web is still lower than that of the native application.

The second limitation of the mobile web is the user interface. For example, the mobile web does not support a “multi-touch” function in which two or more fingers are used, or even if it supports the multi-touching function, the multi-touching function is mixed with a function of scrolling the web page itself, and thus the operation is inconvenient. Another one is a “long click”, and in the case of Amazon Kindle App, for example, a menu which enables a user to input or highlight a note is shown when a word is pushed for a long time. However, in the mobile web, a “Copy” menu which is provided as a default by the browser is only shown when a word is pushed for a long time, which cannot be changed by developers.

The third limitation of the mobile web is the hardware access. While the current location can be identified by GPS in the web page, it is impossible to initiate a camera, acquire compass information, or display an image stored in the terminal. Since many applications implement these functions, the apps should be used to perform such functions.

### SUMMARY OF THE INVENTION

The present invention has been made in an effort to solve the above-described problems associated with prior art, and a first object of the present invention is to provide a method for converting a mobile web application into an app while maintaining the advantages of the mobile web application such as open APIs and mashups.

A second object of the present invention is to provide an apparatus for converting a mobile web application into an app while maintaining the advantages of the mobile web application such as open APIs and mashups.

According to an aspect of the present invention to achieve the first object of the present invention, there is provided a method for converting a mobile web application into a native application, the method comprising the steps of: receiving at least one of a web implementation document that implements the mobile web application and a uniform resource locator (URL) for a local file; separating and analyzing a user interface element of the mobile web application based on the at least one of the web implementation document and the local file; and converting the mobile web application into the native application by mapping the analyzed user interface element to a native control that implements the native application.

The web implementation document may be at least one of a hypertext markup language (HTML) and an extensible markup language (XML) document.

The method for converting the mobile web application into the native application may further comprise the step of packaging the implemented native application and uploading the packaged native application to a server.

The step of separating and analyzing the user interface element of the mobile web application based on the at least one of the web implementation document and the URL for the local file may comprise the step of analyzing the user interface element of the mobile web application with at least one of user interface information, style information, script information, and external object information.

The step of separating and analyzing the user interface element of the mobile web application based on the at least one of the web implementation document and the URL for the local file may comprise the steps of: analyzing at least one of user interface information of a mobile web document that implements the mobile web application and a file including the user interface information that constitutes the mobile web application; analyzing at least one of style information of the web implementation document that implements the mobile web application and a file including the style information that constitutes the mobile web application; analyzing at least one of script information of the web implementation document that implements the mobile web application and a file including the script information that constitutes the mobile web application; and analyzing at least one of external object information of the mobile web document that implements the mobile web application and a file including the external object information that constitutes the mobile web application.

The step of converting the mobile web application into the native application by mapping the analyzed user interface element to a native control that implements the native application may comprise the steps of: disposing the user interface element in the native application by mapping the user interface element to the native control by referring to a mapping table for mapping the user interface element of the mobile web application to the native control of the native application; applying the style information that implements the mobile web application to style attributes of the native control; connecting the script information that implements the mobile web application to attribute information of the native control; and disposing the external object information in the native application by connecting the external object information that implements the mobile web application to the native control.

The method for converting the mobile web application into the native application may further comprise the step of converting the mobile web application into the native application by correcting native control information of the mapped native application and additionally mapping information of the native application, which is not mapped to the native control, to the native application.

The step of converting the mobile web application into the native application by correcting the native control information of the mapped native application and additionally mapping the information of the native application, which is not mapped to the native control, to the native application may comprise the steps of: moving the native control or changing at least one of size information and attribute information of the native control; additionally applying style information, which is not applied to the native control, to the native control; changing and storing a source code of the script information; and implementing the native application by changing the link and parameter of the external object disposed in the native control and deleting external object information which is not mapped to the native control or replacing the external object information with another external object.

According to an aspect of the present invention to achieve the second object of the present invention, there is provided an apparatus of converting a mobile web application into a native application, the apparatus comprising: a web application reader for receiving at least one of a web implementation document that implements the mobile web application and a uniform resource locator (URL) for a local file; a web application analyzer for analyzing a user interface element of the mobile web application based on the at least one of the web implementation document and the local file provided by the web application reader; and a native control mapping module for mapping the user interface element analyzed by the web application analyzer to a native control that implements the native application.

The web implementation document may be at least one of a hypertext markup language (HTML) and an extensible markup language (XML) document.

The web application analyzer may comprise: a user interface analysis module for analyzing at least one of the user interface element that implements the mobile web application and a file including the user interface information that constitutes the mobile web application; a style analysis module for analyzing at least one of style information of the web implementation document that implements the mobile web application and a file including the style information that constitutes the mobile web application; a script analysis module for analyzing at least one of script information of the web implementation document that implements the mobile web application and a file including the script information that constitutes the mobile web application; and an external object analysis module for analyzing at least one of external object information of the mobile web document that implements the mobile web application and a file including the external object information that constitutes the mobile web application.

The apparatus for converting the mobile web application into the native application may further comprise an app author for implementing the native application by correcting native control information of the mapped native application and additionally mapping information of the native application, which is not mapped to the native control, to the native application.

The apparatus for converting the mobile web application into the native application may further comprise: an app packaging module for packaging the native application implemented by the app author to be uploaded to a server; and an app upload module for uploading the native application packaged by the app packaging module to the server.

The apparatus for converting the mobile web application into the native application may further comprise an app market for distributing the native application uploaded from the app upload module to the server.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram for comparing a mobile web application with a smart phone-dedicated native application (hereinafter, the term “app” has the same meaning as the native application);

FIG. 2 is a block diagram illustrating an apparatus for converting a mobile web application into a native application in accordance with an exemplary embodiment of the present invention;

FIG. 3 is a conceptual diagram illustrating the functions of a user interface analysis module in accordance with an exemplary embodiment of the present invention;

FIG. 4 is a conceptual diagram illustrating the functions of a style analysis module in accordance with an exemplary embodiment of the present invention;

FIG. 5 is a conceptual diagram illustrating the functions of a script analysis module in accordance with an exemplary embodiment of the present invention;

FIG. 6 is a conceptual diagram illustrating the functions of an external object analysis module in accordance with an exemplary embodiment of the present invention;

FIG. 7 is a conceptual diagram illustrating an app screen generated by mapping of a native control in accordance with an exemplary embodiment of the present invention;

FIG. 8 is a flowchart illustrating a method for converting a mobile web application into a native application in accordance with another exemplary embodiment of the present invention; and

FIG. 9 is a simplified flowchart illustrating a method for converting a mobile web application into a native application in accordance with another exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the spirit and scope of the invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. Like reference numerals in the drawings denote like elements, and thus repeated descriptions will be omitted.

In the following exemplary embodiments of the present invention, the terms “native application” and “app”, an abbreviation thereof, may be used with the same meaning.

Moreover, object elements that implement a native application may be referred to as a native control, and object elements that implement a mobile web application may be referred to as a user interface element.

Furthermore, a language that implements a web such as a hypertext markup language (HTML) and an extensible markup language (XML) document may be defined as a web implementation language.

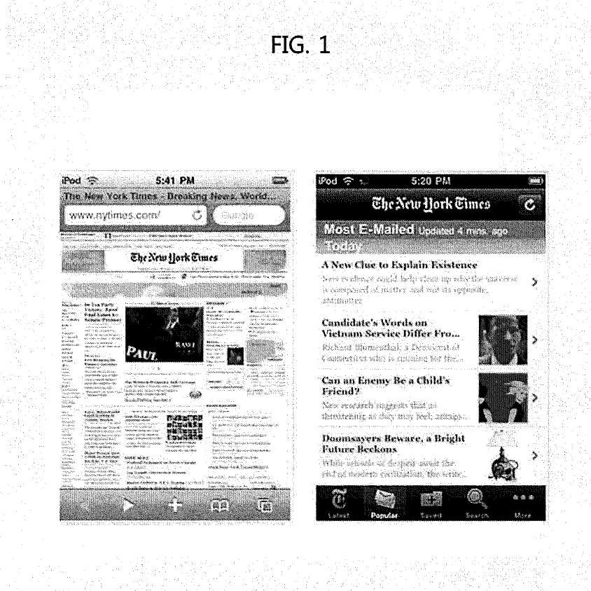

FIG. 1 is a conceptual diagram for comparing a mobile web application with a smart phone-dedicated native application (hereinafter, the term “app” has the same meaning as the native application).

Referring to FIG. 1, the left image of FIG. 1 shows a mobile web application and the right image of FIG. 1 shows a smart phone-dedicated native application.

The mobile web application (in the form of a web implementation document such as *.html document) is converted from a typical web page form to be provided in a mobile terminal.

While the mobile web application is loaded through a web browser of a smart phone, the app of the smart phone (in the form of *.apk in the case of Android) is independently installed and executed in the smart phone.

User interface elements of the mobile web application shown in the left of FIG. 1 are displayed in such a manner that tags such as <img>, <input type=“text”>, <input type=“button”>, <input type=“checkbox”>, <input type=“radio”>, etc. in a document composed of a web implementation language such as an HTML document are viewed through the mobile web browser.

The user interface elements displayed on the app of the smart phone are independent user interface controls which are easily dragged and dropped in a drag-and-drop manner during app development.

In order to convert the mobile web application into a native application of the smart phone, i.e., an app, the output in the form of an HTML document of the mobile web application should be converted into the form of a smart phone app (e.g., in the form of *.apk). That is, the user interface elements included in the form of tags of a web implementation document in the mobile web page should be mapped to a native control as a user interface for the smart phone app to convert the mobile web application into the native application.

For example, in order to map the user interface elements, which are included in the form of tags in the mobile web page, to the native control for the smart phone app, the user interface elements of the mobile web application may be analyzed using an analysis module for analyzing the user interface, style, script, and external object, which constitute the user interface of the mobile web application.

In the following exemplary embodiment of the present invention, the elements including the user interface, style, script, and external object, which constitute the user interface of the mobile web application, will be collectively referred to as a user interface element.

The mobile web application can be converted into a smart phone app by mapping the user interface element analyzed by the analysis module to the native control that implements the native application.

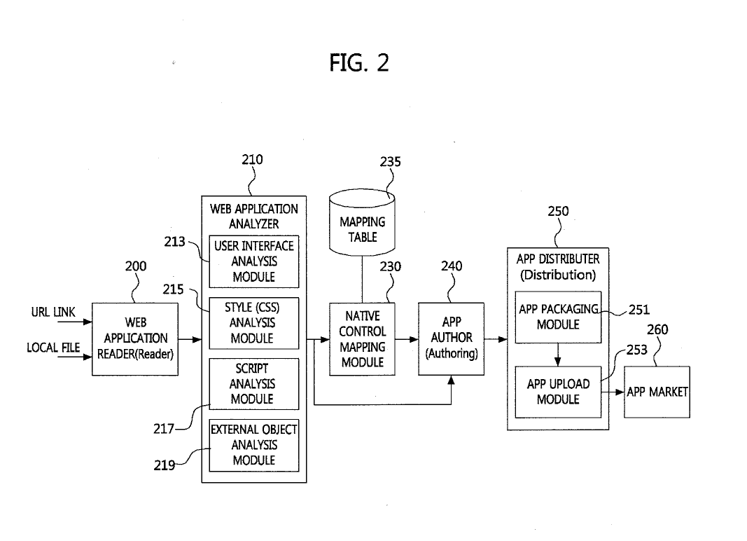

FIG. 2 is a block diagram illustrating an apparatus for converting a mobile web application into a native application in accordance with an exemplary embodiment of the present invention.

Referring to FIG. 2, the apparatus for converting the mobile web application into the native application may comprise a web application reader 200, a web application analyzer 210, a mapping table 235, a native control mapping module 230, an app author 240, an app distributer 250, and an app market 260.

The respective components are described independently for convenience of description, and at least two components may be integrated into one component or one component may be divided into a plurality of components. The integration and division of the components are intended to be included within the scope of the present invention without departing from the spirit thereof.

Moreover, each component may not be executed by a single subject in a space or in the same time region but may be executed by individual objects in a different time or space, and such an implementation is included within the scope of the present invention without departing from the spirit thereof.

Furthermore, some components may be not essential components for performing essential functions of the present invention, but may be selective components only for improving the performance. The present invention may be implemented with the essential components required to implement the features of the present invention, except for the components used to improve the performance, and a structure including only the essential components is included within the scope of the present invention without departing from the spirit thereof.

For example, a configuration comprising the components up to the app author that generates an app of a mobile terminal may be included within the scope of an exemplary embodiment of the present invention, and the app distributer and the app market that packages the app, uploads the packaged app, and distributes the uploaded app may not be the essential component for implementing the present invention.

The web application reader 200 may read the configuration and content of an original web application to be converted and authored into a smart phone app and input the configuration and content of the original web application to a system. The web application reader 200 may have a uniform resource locator (URL) link and URL information of a local system file, etc. as input values.

That is, the web application reader 200 may receive a web implementation document that implements the mobile web application and a local file.

In the following exemplary embodiment of the present invention, it is assumed that the URL information of the local file as well as the web implementation document is required to implement the mobile web application for convenience of description. However, if the mapping is possible only with the web implementation document separated and analyzed without the URL information of the local file to implement the native application or if there is no separate local file, the web application reader may receive only the web implementation document other than the local file and implement the native application based on the received document.

The web application analyzer 210 may decompose the user interface element of the web application, input from the web application reader 200, into subelements and analyze the subelements such that the analyzed user interface element is mapped to a native control of the smart phone. The web application analyzer 210 may comprise a user interface analysis module 213, a style analysis module 215, a script analysis module 217, and an external object analysis module 219 according to a typical method for configuring a web application.

That is, the web application analyzer 210 may analysis the user interface element of the mobile web application based on the web implementation document that implements the mobile web application and the local file, which are provided by the web application reader 200.

According to the exemplary embodiment of the present invention, the user interface analysis module 213, the style analysis module 215, the script analysis module 217, and the external object analysis module 219 are examples to analyze the mobile web application, and an additional module may be further included to analyze the mobile web application or a specific module may not be used without departing from the spirit of the present invention.

A typical mobile web application is configured with a combination of external objects such as Applets, Flash, ActiveX, etc. together with XML, CSS style, and script other than HTML. Thus, it is necessary to decompose the entire web application and analyze its content the interface analysis module 213, the style analysis module 215, the script analysis module 217, and the external object analysis module 219.

The interface analysis module 213 analyzes the content of the web application, especially, the content of HTML or XML that constitutes an external user interface such that the web application can be converted into a native control of the app in the later step.

If an element that constitutes the user interface of a typical mobile web application is present as a separate file, the user interface analysis module 213 may analyze the file including the element that constitutes the user interface.

In the following exemplary embodiment of the present invention, the web implementation document and the separate file are analyzed, assuming that a separate file is required to implement the user interface element of the mobile web application in addition to the web implementation document for convenience of description. However, if there is no file required to implement the user interface element or if the native application can be implemented only with the web implementation document that implements the user interface element, the process of analyzing the separate file may be omitted.

That is, the user interface analysis module 213 may analyze the user interface element that implements the mobile web application and a file including user interface information that constitutes the mobile web application.

In the following exemplary embodiment of the present invention, the HTML and XML documents are used, for example, as programming languages for implementing the mobile web application, but the use of another language for constituting the mobile web application as well as these languages may be included within the scope of the present invention without departing from the spirit thereof.

A mobile web application page formed based on the web implementation languages such as HTML and XML may be used with the same meaning as the web implementation document.

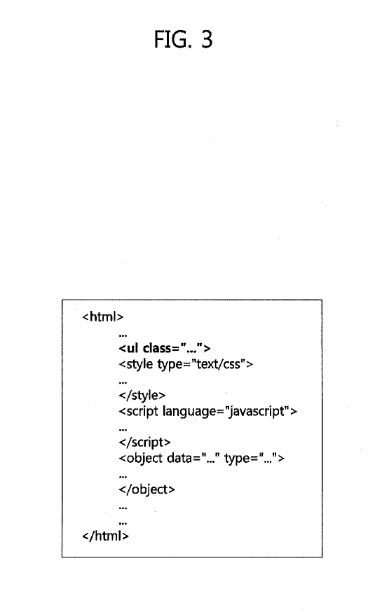

FIG. 3 is a conceptual diagram illustrating the functions of the user interface analysis module 213 in accordance with an exemplary embodiment of the present invention.

Referring to FIG. 3, a web implementation document using the HTML of the mobile web application is shown. <ul Class=“ . . . ”> that indicates the user interface element included in the web implementation document may be analyzed and smart phone control mapping information may be stored in a file or database using a mapping table.

That is, the user interface analysis module 213 may analyze the content of the web implementation document such as HTML or XML that constitutes the external user interface and convert a user interface tag of the mobile web application into a native control that implements a list of the smart phone apps in the next step.

The style analysis module 215 may analyze the style included in the web implementation document such as HTML or XML and the content of a CSS file and map the analyzed style and content to a native control of the app or use the analyzed style and content in app authoring.

The style may be attribute information such as color, font, bold, etc. of the user interface elements of the mobile web application. The style analysis module 215 may store the style attribute information corresponding to the user interface element in a file or database.

Appearance elements such as the style of a typical web application may exist as a CSS file, separately from the HTML file. Thus, the style element included in the CSS file is analyzed and then used in the mapping of the native control of the app and the app authoring.

That is, the style analysis module 215 may analyze the user interface information of the web implementation document that implements the mobile web application and a file including the user interface information.

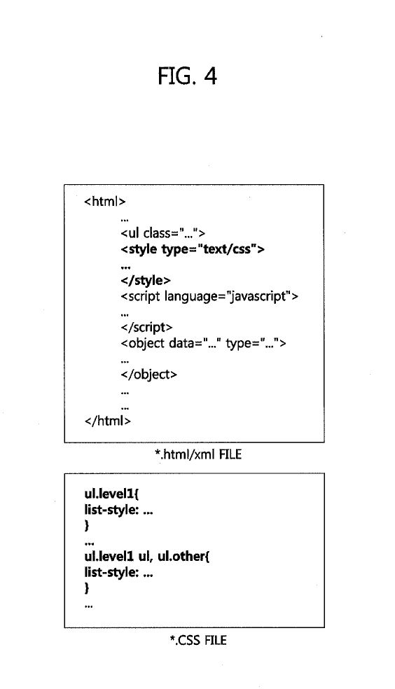

FIG. 4 is a conceptual diagram illustrating the functions of the style analysis module 215 in accordance with an exemplary embodiment of the present invention.

Referring to the top of FIG. 4, the style may include information on style attributes such as color, font, bold, etc. of the user interface elements.

The style analysis module 215 may analyze the style attribute information and store the analyzed style attribute information corresponding to each user interface element in a file or database.

Referring to the bottom of FIG. 4, a CSS file that defines the style attributes, which are not included in the HTML document, is shown. In this case, the style attribute information corresponding to the user interface information may also be stored in a file or database.

The script analysis module 217 may analyze the script file and the script content in the HTML such that the analyzed script content can be used in the app authoring later.

A typical web application stores the functional logic content other than the appearance elements configured with HTML and CSS styles in a separate script file (e.g., *.js file) or in an HTML document.

The script analysis module 217 may analyze the separate script file or the content of the HTML script and use the analyzed script file or HTML script in the app authoring.

The script analysis module 217 may analyze the script information of the web implementation document that implements the mobile web application and a file including the script information that constitutes the mobile web application.

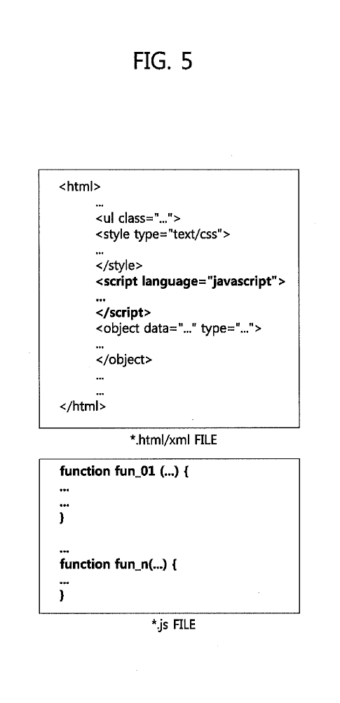

FIG. 5 is a conceptual diagram illustrating the functions of the script analysis module 217 in accordance with an exemplary embodiment of the present invention.

Referring to the top of FIG. 5, the script analysis module 217 may be responsible for logic that runs behind the user interface displayed on the screen. The script analysis module 217 may store the content of a script source in a file or database and, in the case of an event code of a specific user interface, may store information on the connection to the corresponding user interface in a file or database together.

Referring to the bottom of FIG. 5, the script may not be included in the HTML, but may be present as a separate file (e.g., *.js). Even in this case, the script analysis module 217 may store the content of the script source analyzed from the separate file in a file or database and, in the case of an event code of a specific user interface, may store information on the connection to the corresponding user interface in a file or database together.

The external object analysis module 219 may analyze the type and content of an external object present in the mobile web application such that the analyzed script content can be used in the app authoring later.

A typical web application may include external objects such as Flash (or Flex), Silverlight, Applet, ActiveX, and various video and audio formats in addition to the standard web content of HTML, CSS, and script.

The external object analysis module 219 may analyze the external object such that the analyzed external object can be used by the native control mapping module 230 and the app author 240 later.

If an element that constitutes the external object is present as a separate file, the external object analysis module 219 may analyze a file including the element that constitutes the external object.

The external object analysis module 219 may analyze external object information of the mobile web document that implements the mobile web application and a file including the external object information that constitutes the mobile web application.

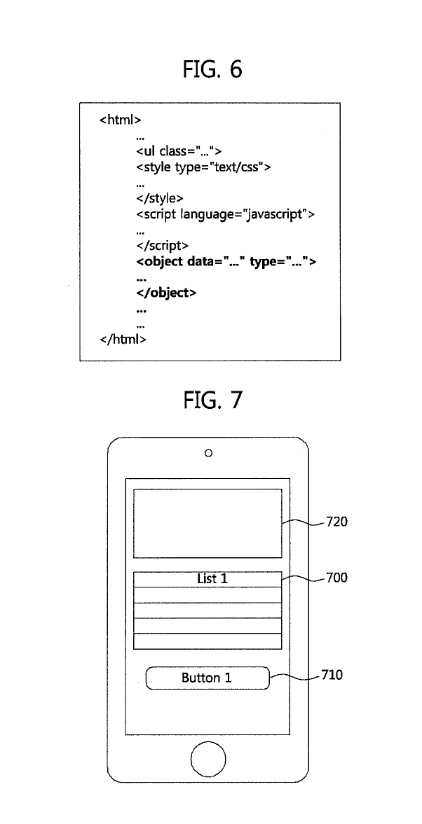

FIG. 6 is a conceptual diagram illustrating the functions of the external object analysis module 219 in accordance with an exemplary embodiment of the present invention.

Referring to FIG. 6, the HTML document may include a link of the external object such as Flash, Applet, ActiveX, etc.

The external object analysis module 219 may store URL information as the link information to the external object in a file or database and, if there is a parameter required to execute the external object, may store the parameter in a file or database together. If there is a smart phone app control capable of loading the corresponding external object, the mapping information may be stored together.

The information stored in the file or database based on the analysis results of the user interface analysis module 213, the style analysis module 215, the script analysis module 217, and the external object analysis module 219, which are included in the web application analyzer 210, may be used by the native control mapping module 230 and the app author 240 behind the web application analyzer 210.

The mapping table 235 may connect the user interface element and the native control element such that the user interface element of the mobile web application analyzed by the web application analyzer 210 can be mapped to the native control of the native application by the native control mapping module 230.

The native control mapping module 230 may map the user interface element of the web application, especially, the user interface elements such as a text box, button, list, etc, to the native control of the smart phone app in order to convert the web application format into a smart phone app format.

The native control mapping module 230 maps the user interface elements in the HTML page to corresponding native controls by referring to the mapping table 235 based on the analysis results of the user interface analysis module 213 in the web application analyzer 210 in the previous step.

Here, it is possible to provide visual attributes to the native control that implements the native application by connecting to the mapped native control based on the style content analyzed by the style analysis module 215 included in the web application analyzer 210 in the previous step.

Since the script contains few contents related to the user interface, the analysis results of the script analysis module 217 included in the web application analyzer 210 may be used in assignment between the native control and method calls by the native control mapping module 230, and most of the remaining analysis results of the script analysis module 217 may be used by the app author 240 later.

A part that can be replaced with the native control may be mapped to the native control based on the analysis results of the external object analysis module 219 in the web application analyzer 210 in the previous step, and a part having a difference between the external object and the native control or a part that cannot be mapped to the native control may be processed by the app author 240 later.

FIG. 7 is a conceptual diagram illustrating an app screen generated by mapping of the native control in accordance with an exemplary embodiment of the present invention.

Referring to FIG. 7, the app screen may comprise native controls such as a menu list 700, a section button 710, and an external object controller 720.

In the following exemplary embodiment, the app screen is merely an example used for convenience of description, and any other app screens may be included within the scope of the present invention without departing from the spirit thereof.

The native control of the app may be disposed in the user interface elements such as the menu list 700 and the selection button 710, which can be selected by a user, and the style analyzed by the style analysis module may be applied to the native control of the corresponding app.

Moreover, additional script information required to execute a specific event may be stored, and the external object information analyzed by the external object analysis module may be disposed on the app screen.

The native control mapping module may map the user interface element to the native control of the smart phone app to be disposed on the app screen based on the analysis results of the user interface elements of the mobile web application in the HTML/XML documents, in which the mapping relationship with the smart phone app control is clear after converting the mobile web application into the smart phone app. For example, it is possible to dispose a list control as a user interface element corresponding to a user interface tag in the HTML/XML documents on the app screen implemented in the smart phone.

Next, it is possible to read the style attribute information stored by the style analysis module included in the web application analyzer and apply visual style attributes such as color, font, outline, etc. to a control disposed in the app screen of the smart phone app.

Then, if it is determined there is a script such as an event processing connected to the control disposed on the app screen of the smart phone app as a result of the analysis of the script by the script analysis module included in the web application analyzer, it is possible to store a reference to the corresponding script in event attributes of the control of the corresponding smart phone.

If there is mapping information on the native control capable of loading an external object as a result of the analysis of the external object by the external object analysis module included in the web application analyzer, it is possible to dispose the corresponding native control on the app screen and assign the external object link and parameter information to control attributes.

The app author may yield a complete smart phone app by performing an additional app authoring process based on the results calculated from the native control mapped by the native control mapping module.

The app author may be constructed in a graphic user interface (GUI) environment to facilitate user operations such as rearrangement, attribute change, script correction, etc. of the native control.

The app author may perform rearrangement and attribute change of the controls which are automatically mapped by the native control mapping module. Moreover, the app author may perform mapping and attribute setting of the control which is not automatically mapped, application of the style content which is not reflected to the control, conversion and correction on the script which is not mapped to the control, additional customizing on the external object which is mapped to the native control, and replacement of the external object which is not mapped to the control.

That is, the app author may perform the remaining app authoring process, which is not performed by the native control mapping module, and a completing process.

The app author may perform position change, size change, attribute change, etc. on the smart phone app controls which are automatically disposed by the user interface analysis module and the native control mapping module. Moreover, the app author may additionally apply style attributes, which are not automatically reflected to the control by the style analysis module and the native control mapping module.

Further, the app author may change a source code of the script whose reference is stored in the control by the script analysis module and the native control mapping module to a source code in a language suitable for each smart phone (e.g., change the JavaScript to Objective-C or Java code) and store the changed source code.

In addition, if it is necessary to replace the external object with the native control and dispose the controls on the app screen, the app author may change the external object URL, parameter, etc. and, in the case of an external object which cannot be received (loaded) in the smart phone app control, i.e., which cannot be mapped to the control, may replace the external object with an “alternate image” or delete the external object.

The app distributer for attributing the app in the app market, for example, may comprise an app packaging module 251 and an app upload module 253.

The app packaging module may package the smart phone app completed by the app author in the previous step to be uploaded to the app market or to be directly distributed to a user. For example, the app packing module packages an Android app in the form of *.apk.

The app upload module may upload the smart phone app packaged by the app packaging module to the app market such as the Apple's App Store, Android market, etc, or to a specific position designated by the user. In the case where the app market is equipped with a unique authentication process, an upload process, etc., this step may be replaced with the corresponding process.

That is, the method for converting the mobile web application into the native application according to the present invention combines the advantages of the mobile web application and those of the smart phone app, and thus it is possible to use various open APIs and develop easier and faster mashups. Moreover, the converted native application has excellent speed and performance compared to the mobile web application and is provided in the form of a smart phone app, which thus can be freely registered, sold, and downloaded through the app market.

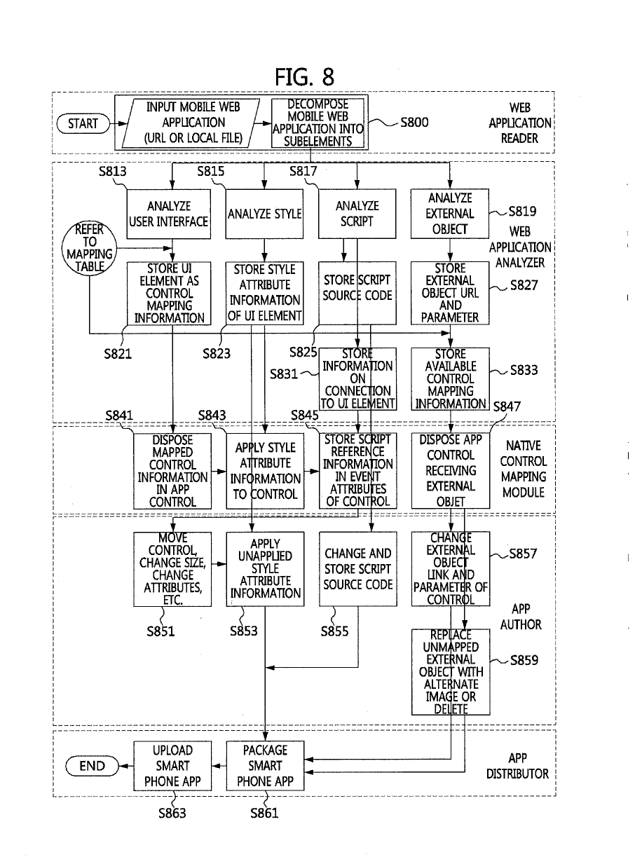

FIG. 8 is a flowchart illustrating a method for converting a mobile web application into a native application in accordance with another exemplary embodiment of the present invention.

Referring to FIG. 8, a web application reader may receive a mobile web application (Step S800).

The web application reader may receive information that constitutes the mobile web application from a URL or a URL for a local file.

The web application reader may receive a web implementation document that implements the mobile web application and a local file.

The web application analyzer may decompose the mobile web application into subelements based on the information transmitted from the web application reader.

That is, the web application analyzer may separate and analyze the user interface element of the mobile web application based on the web implementation document and the local file provided by the web application reader.

The web application analyzer may perform an analysis of the user interface (Step S813), an analysis of the style (Step S815), an analysis of the script (Step S817), and an analysis of the external object (Step S819) using a user interface analysis module, a style analysis module, a script analysis module, and an external object analysis module.

Steps S813 to S819 are an example for describing the analysis of each of the elements that constitute the mobile web application for convenience of description, and an additional step of analyzing an element that constitutes the mobile web application may be used without departing from the spirit and scope of the invention.

In the step of analyzing the user interface (Step S813), user interface information of the mobile web documents that implements the mobile web application and a file including the user interface information that constitutes the mobile web application may be analyzed.

In the step of analyzing the style (Step S815), style information of the mobile web documents that implements the mobile web application and a file including the style information that constitutes the mobile web application may be analyzed.

In the step of analyzing the script (Step S817), script information of the mobile web documents that implements the mobile web application and a file including the script information that constitutes the mobile web application may be analyzed.

In the step of analyzing the external object (Step S819), external object information of the mobile web documents that implements the mobile web application and a file including the external object information that constitutes the mobile web application may be analyzed.

Through the step of analyzing the user interface (Step S813), the user interface element in the mobile web application in the form of HTML or XML document may be stored as control mapping information by referring to a mapping table (Step S821).

The style element in the mobile web application in the form of HTML or XML document or the content of a CSS file may be analyzed in the step of analyzing the style (Step S815), and the analyzed style information may be stored in a file or database (Step S823).

The script in the mobile web application and the content of a separate script file may be analyzed in the step of analyzing the script (Step S817), and a source code of the script may be stored (Step S825). Moreover, through the step of analyzing the script (Step S817), the corresponding script and information on the connection to the user interface may be stored (Step S831)

Moreover, through the step of analyzing the external object (Step S819), external object information such as Flash (or Flex), Silverlight, Applet, ActiveX, and various video and audio formats included in a typical web application may be analyzed.

Based on the results analyzed in Step S819, the external object URL and parameter may be stored (Step S827). Moreover, the available control mapping information may be stored by referring to the mapping table (Step S833).

The native control mapping module may dispose the user interface element and the mapped control information in the smart phone app control (Step S841) through Step S821.

The style attribute information stored by the style analysis may be applied and used in the smart phone app authoring (Step S843).

Furthermore, based on the stored script information connected to the user interface element, script reference information may be stored in event attributes of the control (Step S845), and the app control may be disposed based on the available control mapping information by analyzing the external object information and referring to the mapping table (Step S847).

That is, by referring to the mapping table for mapping the user interface element of the mobile web application to the native control of the native application, the user interface element may be mapped to the native control to be disposed in the native application, the style information that implements the mobile web application may be applied to the style attributes of the native control, the script information that implements the mobile web application may be connected to the attribute information of the native control, and the external object information that implements the mobile web application may be connected the native control to be disposed in the native application.

Through Step S845, the app author may perform the control movement, size change, attribute change, etc. based on the script reference stored in the event attributes of the control (Step S851).

Style attribute information, which is not applied to the control of the smart phone app by the native control mapping module, among the style elements analyzed by the style analysis module may be applied to the smart phone app by the app author (Step S853).

The source code of the script may be changed and stored by the app author (Step S855).

After the app control receiving the external object is disposed in Step S847, the external object link and parameter of the control may be changed (Step S857). Moreover, the external object, which is not mapped, may be replaced with an alternate image or deleted (Step S859).

Smart phone app may be packaged (Step S861) with the app to which the style attribute information is applied in Step S853, the information containing the source code of the script changed and stored in Step S855, the information containing the external object link and parameter of the control changed in Step S857, and the external object replaced with an alternate image or deleted in Step S859.

That is, the app author may move the native control, change the size and attribute information of the native control, additionally apply the style information, which is not applied to the native control among the style information, to the native control, change and store the source code of the script information, change the link and parameter of the external object disposed in the native control, and delete the external object information, which is not mapped to the native control, or replace the external object information, thereby implementing the native application.

The packaged smart phone app may be uploaded (Step S863).

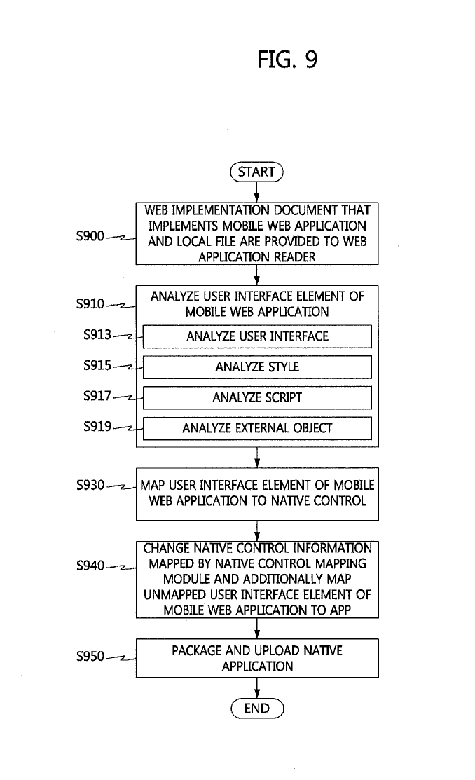

FIG. 9 is a simplified flowchart illustrating a method for converting a mobile web application into a native application in accordance with another exemplary embodiment of the present invention.

Referring to FIG. 9, the web application reader may receive a web implementation document that implements the mobile web application and a local file (Step S900).

The web application reader may read the configuration and content of an original web application to be converted and authored into a smart phone app and input them to a system. The web application may include a URL link and a URL for a local system file as input values.

Next, the web application analyzer may analyze user interface elements such as a user interface, style, script, and external object (Step S910).

In the step of analyzing the user interface (Step S913), a user interface tag of a mobile web document and a file including user interface information that constitutes the mobile web application may be analyzed. In the step of analyzing the style (Step S915), style information of the mobile web document and a file including the style information that constitutes the mobile web application may be analyzed. In the step of analyzing the script (Step S917), script information of the mobile web document and a file including the script information that constitutes the mobile web application may be analyzed. In the step of analyzing the external object (Step S919), external object information of the mobile web document and a file including the external object information that constitutes the mobile web application may be analyzed.

While the present embodiment of the present invention includes only the above-described steps of analyzing the user interface elements that constitute the mobile web application, an additional step of analyzing an element that constitutes the mobile web application may be included without departing from the spirit and scope of the invention.

The web application analyzer may decompose the content of the web application input by the web application reader into subelements and analyze the subelements so as to be mapped to a native control of the smart phone for implementing the app. The web application analyzer may comprise a user interface analysis module, a style analysis module, a script analysis module, and an external object analysis module according to a typical method for configuring a web application.

A typical mobile web application is configured with a combination of external objects such as Applets, Flash, ActiveX, etc. together with XML, CSS style, and script other than HTML, and thus it is necessary to decompose the entire web application and analyze its content through the interface analysis module, the style analysis module, the script analysis module, and the external object analysis module.

That is, the web application analyzer may separate and analyze the user interface element of the mobile web application based on the web implementation document and the local file provided by the web application reader.

The native control mapping module may map the user interface element analyzed and separated to a native control of the native application (Step S930).

The native control mapping module may map the user interface (UI) element of the web application, especially, the user interface elements such as a text box, button, list, etc, to the native control of the smart phone app in order to convert the web application format into a smart phone app format.

The native control mapping module maps the UI elements in the HTML page to corresponding native controls based on the analysis results of the user interface analysis module in the web application analyzer in the previous step.

That is, by referring to the mapping table for mapping the user interface element of the mobile web application to the native control of the native application, the user interface element may be mapped to the native control to be disposed in the native application, the style information that implements the mobile web application may be applied to the style attributes of the native control, the script information that implements the mobile web application may be connected to the attribute information of the native control, and the external object information that implements the mobile web application may be connected the native control to be disposed in the native application.

The app author may change the native control information mapped by the native control mapping module and additionally map the user interface element, which is not mapped, to the native application (Step S940).

The app author may yield a complete smart phone app by performing an additional app authoring process based on the results calculated from the native control mapped by the native control mapping module.

The app author may be constructed in a graphic user interface (GUI) environment to facilitate user operations such as rearrangement, attribute change, script correction, etc. of the native control. The app author may perform rearrangement and attribute change of the controls which are not automatically mapped by the native control mapping module in the previous step. Moreover, the app author may perform mapping and attribute setting of the control which is not automatically mapped, application of the style content which is not reflected to the control, conversion and correction on the script which is not mapped to the control, additional customizing on the external object which is mapped to the native control, and replacement of the external object which is not mapped to the control.

That is, the app author may move the native control, change the size and attribute information of the native control, additionally apply the style information, which is not applied to the native control among the style information, to the native control, change and store the source code of the script information, change the link and parameter of the external object disposed in the native control, and delete the external object information, which is not mapped to the native control, or replace the external object information, thereby implementing the native application.

The native application may be packaged and uploaded (Step S950).

The app packaging module may package the smart phone app completed by the app author in the previous step to be uploaded to a server or to be directly distributed to a user. For example, the app packing module packages an Android app in the form of *.apk.

Moreover, the app upload module may upload the smart phone app packaged by the app packaging module to the app market such as the Apple's App Store, Android market, etc, or to a specific position designated by the user. In the case where the app market is equipped with a unique authentication process, an upload process, etc., this step may be replaced with the corresponding process.

As described above, according to the method for converting the mobile web application into the native application and the apparatus using the method in accordance with the exemplary embodiments of the present invention, it is possible to provide a service optimized for a mobile device to a user by analyzing the web implementation document that constitutes the mobile web application and the URL for the local file that implements other mobile web application and by mapping the analyzed web implementation document and URL to a native control that implements the native application.

As a result, it is possible to provide a service optimized for a mobile device, which is the advantage of the native application of the smart phone, while maintaining the advantages of the mobile web application such as open APIs and mashups.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A method for converting a mobile web application into a native application, the method comprising:
receiving at least one of a web implementation document that implements the mobile web application and a uniform resource locator (URL) for a local file;
separating and analyzing a user interface element of the mobile web application based on the at least one of the web implementation document and the local file; and
converting the mobile web application into the native application by mapping the analyzed user interface element to a native control that implements the native application.

2. The method of claim 1, wherein the web implementation document is at least one of a hypertext markup language (HTML) and an extensible markup language (XML) document.

3. The method of claim 1, further comprising packaging the implemented native application and uploading the packaged native application to a server.

4. The method of claim 1, wherein the separating and analyzing the user interface element of the mobile web application based on the at least one of the web implementation document and the URL for the local file comprises:
analyzing the user interface element of the mobile web application with at least one of user interface information, style information, script information, and external object information.

5. The method of claim 1, wherein the separating and analyzing the user interface element of the mobile web application based on the at least one of the web implementation document and the URL for the local file comprises:
analyzing at least one of user interface information of a mobile web document that implements the mobile web application and a file including the user interface information that constitutes the mobile web application;
analyzing at least one of style information of the web implementation document that implements the mobile web application and a file including the style information that constitutes the mobile web application;
analyzing at least one of script information of the web implementation document that implements the mobile web application and a file including the script information that constitutes the mobile web application; and
analyzing at least one of external object information of the mobile web document that implements the mobile web application and a file including the external object information that constitutes the mobile web application.

6. The method of claim 1, wherein the converting the mobile web application into the native application by mapping the analyzed user interface element to a native control that implements the native application comprises:
disposing the user interface element in the native application by mapping the user interface element to the native control by referring to a mapping table for mapping the user interface element of the mobile web application to the native control of the native application;
applying the style information that implements the mobile web application to style attributes of the native control;
connecting the script information that implements the mobile web application to attribute information of the native control; and
disposing the external object information in the native application by connecting the external object information that implements the mobile web application to the native control.

7. The method of claim 1, further comprising
converting the mobile web application into the native application by correcting native control information of the mapped native application and additionally mapping information of the native application, which is not mapped to the native control, to the native application.

8. The method of claim 7, wherein the converting the mobile web application into the native application by correcting the native control information of the mapped native application and additionally mapping the information of the native application, which is not mapped to the native control, to the native application comprises:
moving the native control or changing at least one of size information and attribute information of the native control;
additionally applying style information, which is not applied to the native control, to the native control;
changing and storing a source code of the script information; and
implementing the native application by changing the link and parameter of the external object disposed in the native control and deleting external object information which is not mapped to the native control or replacing the external object information with another external object.

9. An apparatus of converting a mobile web application into a native application, the apparatus comprising:
a web application reader for receiving at least one of a web implementation document that implements the mobile web application and a uniform resource locator (URL) for a local file;
a web application analyzer for analyzing a user interface element of the mobile web application based on the at least one of the web implementation document and the local file provided by the web application reader; and
a native control mapping module for mapping the user interface element analyzed by the web application analyzer to a native control that implements the native application.

10. The apparatus of claim 9, wherein the web implementation document is at least one of a hypertext markup language (HTML) and an extensible markup language (XML) document.

11. The apparatus of claim 9, wherein the web application analyzer comprises:
a user interface analysis module for analyzing at least one of the user interface element that implements the mobile web application and a file including the user interface information that constitutes the mobile web application;
a style analysis module for analyzing at least one of style information of the web implementation document that implements the mobile web application and a file including the style information that constitutes the mobile web application;
a script analysis module for analyzing at least one of script information of the web implementation document that implements the mobile web application and a file including the script information that constitutes the mobile web application; and
an external object analysis module for analyzing at least one of external object information of the mobile web document that implements the mobile web application and a file including the external object information that constitutes the mobile web application.

12. The apparatus of claim 9, further comprising an app author for implementing the native application by correcting native control information of the mapped native application and additionally mapping information of the native application, which is not mapped to the native control, to the native application.

13. The apparatus of claim 12, further comprising:
an app packaging module for packaging the native application implemented by the app author to be uploaded to a server; and
an app upload module for uploading the native application packaged by the app packaging module to the server.

14. The apparatus of claim 13, further comprising an app market for distributing the native application uploaded from the app upload module to the server.
